(19) United States
(12) Patent Application Publication
(10) Pub. No.: US 2014/0096046 A1
(43) Pub. Date: Apr. 3, 2014

(54) COMPOSITE APPLICATION FRAMEWORK

(71) Applicant: ORACLE INTERNATIONAL CORPORATION, Redwood Shores, CA (US)

(72) Inventors: QIU ZHONG, Greenwood Village, CO (US); GURBINDER SINGH BALI, Highlands Ranch, CO (US)

(21) Appl. No.: 13/910,452

(22) Filed: Jun. 5, 2013

Related U.S. Application Data
(60) Provisional application No. 61/707,067, filed on Sep. 28, 2012.

(51) Int. Cl. G06F 3/0481

(52) U.S. Cl. CPC G06F 3/0481
USPC 715/765

(57) ABSTRACT

Various arrangements for managing a layout within a composite application is presented. A selection of a first application widget may be received. A selection of a second application widget may also be received. The content of the first and second application widget may be based at least in part on content of the selected record within the database interface presented as part of the composite application. A definition of a display layout configuration may be received which defines display sizes and display positions of the first application widget, the second application widget, and the database interface for simultaneous presentation. The first application widget, the second application widget, and the database interface may be arranged in accordance with the display layout configuration. The composite application may be presented having the first application widget, the second application widget, and the database interface arranged according to the display layout configuration.

### CROSS-REFERENCES

This application claims priority from co-pending U.S. Provisional Patent Application No. 61/707,067, filed Sep. 28, 2012, entitled “Composite Application Framework using Generic URLs,” which is hereby incorporated by reference, as if set forth in full in this document, for all purposes.

This application is related to co-pending U.S. patent application Ser. No. 13/149,017, filed May 31, 2011, entitled “Generation of Generic Universal Resource Indicators” and U.S. patent application Ser. No. 13/149,031, filed May 31, 2011, entitled “Use of Generic Universal Resource Indicators.” Each of these applications are hereby incorporated by reference, as if set forth in full in this document for all purposes.

### BACKGROUND

When accessing a record from a database, a user may want to also view information relevant to the database record. For example, if a user is accessing a database record about a client, the user may find it useful to simultaneously view a map showing the location of the client's headquarters. However, the more information a user attempts to view simultaneously, the more difficult it may be for the various pieces of information to be presented in a logical and useful manner. As such, an overload of information being displayed to the user may negatively impact the user's efficiency and user experience while interacting with the database.

### SUMMARY

Various arrangements for managing a layout within a composite application are presented. A method for managing a layout within a composite application may be presented. The method may include receiving, by a computer system, selection of a first application widget. Content of the first application widget may be based at least in part on content of a selected record within a database interface presented as part of the composite application. The method may include receiving, by the computer system, selection of a second application widget. Content of the second application widget may be based at least in part on content of the selected record within the database interface presented as part of the composite application. The method may include receiving, by the computer system, a definition of a display layout configuration which defines display sizes and display positions of the first application widget, the second application widget, and the database interface for simultaneous presentation. The method may include arranging, by the computer system, the first application widget, the second application widget, and the database interface in accordance with the display layout configuration. The method may include outputting, by the computer system, for presentation the composite application having the first application widget, the second application widget, and the database interface arranged according to the display layout configuration.

Embodiments of such a method may include one or more of the following: The method may include receiving, by the computer system, selection of a record within the database interface of the composite application thereby making the record the selected record. The record may be selected from a plurality of records presented within the database interface of the composite application. The method may include, in response to receiving selection of the record within the database interface of the composite application, modifying, by the computer system, content of the first application widget and content of the second application widget based on content of the record. The first application widget may present content based on a generic universal resource indicator. The method may include creating, by the computer system, the generic universal resource indicator for the selected record by modifying a parameter of a universal resource indicator using data from the selected record. The method may include using, by the computer system, the created generic universal resource indicator to retrieve a resource for presentation within the first application widget. The method may include receiving, by the computer system, the universal resource indicator. The universal resource indicator may include one or more parameters. The method may include presenting, by the computer system, an interface that permits the one or more parameters to be selected and mapped to a variable. The method may include receiving, by the computer system, a selection of the parameter to be mapped to the variable. The method may include receiving, by the computer system, an indication of the variable to map to the parameter of the selection, wherein the variable is a field present within the plurality of records. The second application widget may present content based on a business intelligence definition. The method may include creating, by the computer system, a business intelligence report according to the business intelligence definition for the selected record. The method may include, after presenting the composite application having the first application widget, the second application widget, and the database interface arranged according to the display layout configuration, receiving, by the computer system, a selection of a stored display layout configuration, wherein the stored display layout configuration defines display sizes and display positions for a third application widget and the database interface within the composite application. The method may include outputting, by the computer system, for presentation the composite application having the third application widget and the database interface arranged according to the stored display layout configuration.

Additionally or alternatively, embodiments of such a method may include one or more of the following: The method may include receiving selection of a second record within the database interface thereby making the second record the selected record, wherein the second record is linked to content and the content is only linked to the second record of a plurality of records. The method may include outputting, by the computer system, for presentation the composite application having a third application widget for presenting the content. Receiving the definition of the display layout configuration which defines display sizes and display positions of the first application widget, the second application widget, and the database interface may include dragging and dropping to position and define display sizes of the first application widget, the second application widget, and the database interface within the composite application. The method may include storing, by the computer system, the definition of the display layout configuration.

In some embodiments, a system for managing a layout within a composite application is presented. The system may include one or more processors. The system may include a memory communicatively coupled with and readable by the one or more processors and having stored therein processor-readable instructions. When executed by the one or more processors, the instructions may cause the one or more processors to receive selection of a first application widget. Content of the first application widget may be based at least in part on content of a selected record within a database interface presented as part of the composite application. The instructions may cause the one or more processors to receive selection of a second application widget. Content of the second application widget may be based at least in part on content of the selected record within the database interface presented as part of the composite application. The instructions may cause the one or more processors to receive a definition of a display layout configuration which defines display sizes and display positions of the first application widget, the second application widget, and the database interface for simultaneous presentation. The instructions may cause the one or more processors to arrange the first application widget, the second application widget, and the database interface in accordance with the display layout configuration. The instructions may cause the one or more processors to cause presentation of the composite application having the first application widget, the second application widget, and the database interface arranged according to the display layout configuration.

Embodiments of such a system may include one or more of the following: The instructions may cause the one or more processors to receive selection of a record within the database interface of the composite application thereby making the record the selected record, wherein the record is selected from a plurality of records presented within the database interface of the composite application. The instructions may cause the one or more processors to, in response to receiving selection of the record within the database interface of the composite application, modify content of the first application widget and content of the second application widget based on content of the record. The first application widget may present content based on a generic universal resource indicator. The instructions may cause the one or more processors to create the generic universal resource indicator for the selected record by modifying a parameter of a universal resource indicator using data from the selected record. The instructions may cause the one or more processors to use the created generic universal resource indicator to retrieve a resource for presentation within the first application widget. The instructions may cause the one or more processors to receive the universal resource indicator. The universal resource indicator may include one or more parameters. The instructions may cause the one or more processors to cause presentation of an interface that permits the one or more parameters to be selected and mapped to a variable. The instructions may cause the one or more processors to receive a selection of the parameter to be mapped to the variable. The instructions may cause the one or more processors to receive an indication of the variable to map to the parameter of the selection, wherein the variable is a field present within the plurality of records. The second application widget may present content based on a business intelligence definition. The instructions may cause the one or more processors to create a business intelligence report according to the business intelligence definition for the selected record.

Additionally or alternatively, embodiments of such a system may include one or more of the following: The instructions may cause the one or more processors to, after causing presentation of the composite application having the first application widget, the second application widget, and the database interface arranged according to the display layout configuration, receive a selection of a stored display layout configuration, wherein the stored display layout configuration defines display sizes and display positions for a third application widget and the database interface within the composite application. The instructions may cause the one or more processors to cause presentation of the composite application having the third application widget and the database interface arranged according to the stored display layout configuration. The instructions may cause the one or more processors to receive selection of a second record within the database interface thereby making the second record the selected record, wherein the second record is linked to content and the content is only linked to the second record of a plurality of records. The instructions may cause the one or more processors to cause presentation of the composite application having a third application widget for presenting the content. The processor-readable instructions that cause the one or more processors to receive the definition of the display layout configuration which defines display sizes and display positions of the first application widget, the second application widget, and the database interface may further include processor-readable instructions that cause the one or more processors to receive user input to position and define display sizes of the first application widget, the second application widget, and the database interface within the composite application. The instructions may cause the one or more processors to store the definition of the display layout configuration.

In some embodiments, a non-transitory processor-readable medium for managing a layout within a composite application is presented. The non-transitory processor-readable medium may include processor-readable instructions configured to cause one or more processors to receive selection of a first application widget. Content of the first application widget may be based at least in part on content of a selected record within a database interface presented as part of the composite application. The non-transitory processor-readable medium may include processor-readable instructions configured to receive selection of a second application widget. Content of the second application widget may be based at least in part on content of the selected record within the database interface presented as part of the composite application. The non-transitory processor-readable medium may include processor-readable instructions configured to cause the one or more processors to receive a definition of a display layout configuration which defines display sizes and display positions of the first application widget, the second application widget, and the database interface for simultaneous presentation. The non-transitory processor-readable medium may include processor-readable instructions configured to cause the one or more processors to arrange the first application widget, the second application widget, and the database interface in accordance with the display layout configuration. The non-transitory processor-readable medium may include processor-readable instructions configured to cause the one or more processors to cause presentation of the composite application having the first application widget, the second application widget, and the database interface arranged according to the display layout configuration.

In some embodiments, the non-transitory processor-readable medium may include processor-readable instructions, when executed, further cause the one or more processors to receive selection of a record within the database interface of the composite application thereby making the record the selected record, wherein the record is selected from a plurality of records presented within the database interface of the composite application. The non-transitory processor-readable medium may further include processor-readable instructions, when executed, further cause the one or more processors to in response to receiving selection of the record within the database interface of the composite application, modify content of the first application widget and content of the second application widget based on content of the record.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 illustrates an embodiment of a system for executing a composite application.

FIG. 2 illustrates an embodiment of a module-based system for presenting multiple display layouts.

FIG. 3 illustrates another embodiment of a module-based system for presenting multiple display layouts.

FIG. 4 illustrates an embodiment of composite application.

FIG. 5 illustrates an embodiment of an interface for creating a generic universal resource locator.

FIG. 6 illustrates another embodiment of an interface for creating a generic universal resource locator.

FIG. 7 illustrates an embodiment of an interface for presenting content based on a generic universal resource locator.

FIG. 8 illustrates an embodiment of an interface displaying a business intelligence report.

FIG. 9 illustrates an embodiment of a method for managing a layout within a composite application.

FIG. 10 illustrates an embodiment of a computer system.

FIG. 11 illustrates a screenshot of an embodiment of composite application.

FIG. 12 illustrates a screenshot of another embodiment of composite application.

### DETAILED DESCRIPTION

Dynamic contextual content may be useful to a user interacting with database records. A composite application, which may be presented within a web browser, may allow for a user to interact with data being gathered from multiple sources. Multiple application “widgets” may present information based on a record selected within a database interface. As an example, a user interacting with a database interface of a composite application may select a record corresponding to a business. Within the composite application, an application widget may be presented that presents the user with a map corresponding to an address of the business. Depending on the address present within the record, the map presented by the application widget may be updated.

While such an arrangement may be useful to a user, the arrangement's usefulness may be limited if the information is not presented to the user in a useful layout. For instance, referring to the previous example, if the map is presented on a display to the user as the bottom quarter of the composite application, the displayed map may be so short vertically that the map does not provide useful information to the user. Depending on the number of application widgets presented within the composite application, the types of application widgets presented within the composite application, and characteristics of the user's display (e.g., computer monitor, laptop screen, tablet screen), the configuration of the display layout may be modified to increase usability. For instance, the display size of application widgets, the display location of application widgets, the display size of a database interface, the display location of the database interface, and which applications widgets are currently presented or hidden (e.g., minimized) may be defined by a display layout configuration which controls how frames are presented within a browser.

A display layout configuration may be created by an end user of the composite application by dragging and dropping application widgets and/or the database interface within the composite application. Created display layout configurations may be stored and reloaded at a later time, such as during a future session with the composite application. Further, display layout configurations may be publicly shared such that multiple users can use the same display layout configuration. In some embodiments, display layout configurations can be linked to particular database records, such that when the record is accessed a particular display layout configuration is made active, which may result in one or more different application widgets being executed and displayed.

Further, application widgets can be configured to provide information specific to a database record selected by the user. For example, two types of application widgets are “generic universal resource locator” (URL) application widgets and “business intelligence” application widgets. A generic URL application widget may construct a URL (or, more generally, a universal resource indicator (URI)) based on a record selected by a user within a database interface of the composite application. For instance, one or more parameters of a generic URL may be based on data present within the database record selected by the user. For example, a generic URL may be a link to an internet resource that provides maps. The URL to the map resource may be modified to contain the zip code indicated in the selected URL, such that the application widget for the map resource is configured to display a map displaying the geographic region of the zip code of the selected database record. Where the generic URL application widget is presented within the composite application may be defined based on the display layout configuration defined and/or loaded by the user. A user may provide a URL (or URI) and define how the URL is modified to create a generic URL (or URI) which may be used to access a resource for various database records.

Business intelligence reports may be constructed for records within a database. A user may define how fields within a record are to be used to create a business intelligence report. The business intelligence report may be created based on information present within the database record and/or based on information retrieved from other sources, such as databases accessible to the composite application. A user may provide a definition of how a business intelligence report is to be generated. By a user selecting different records within the database interface of the composite application, the user may view and/or interact with a business intelligence report generated for the selected record, wherein the business intelligence report was created based on the definition of the business intelligence report created by the user (or some other user). As such, the business intelligence report can be generated for whichever database record is selected by the user. Where the business intelligence application widget is presented within the composite application may be defined based on the display layout configuration defined and/or loaded by the user. Some business intelligence reports may include graphs created based on data present within the selected database record or summarized data created based on the data present within the selected record.

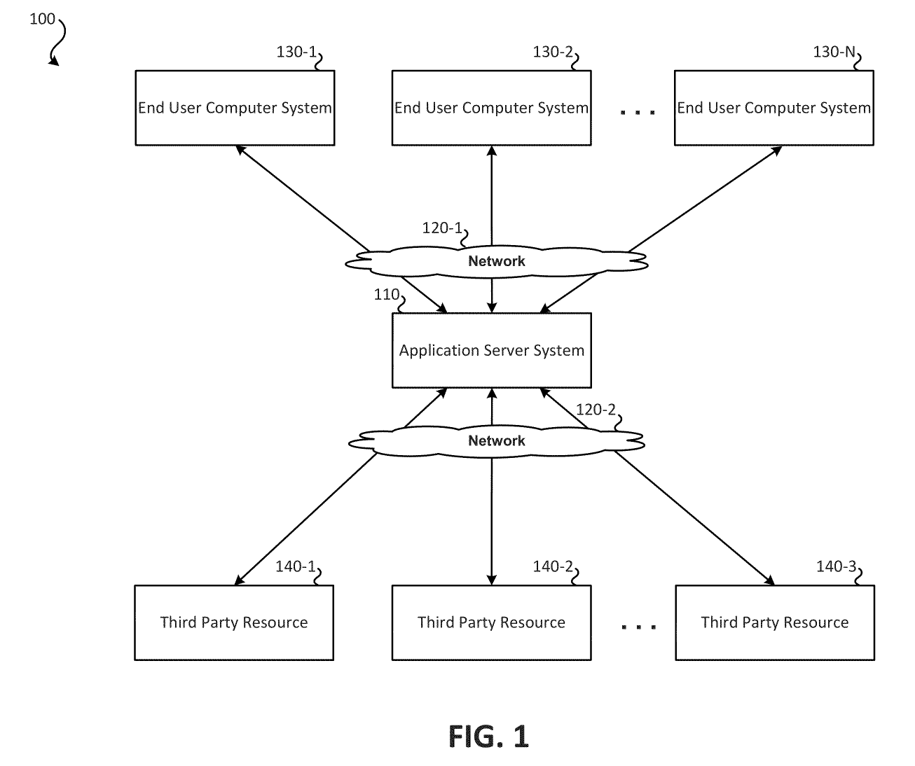

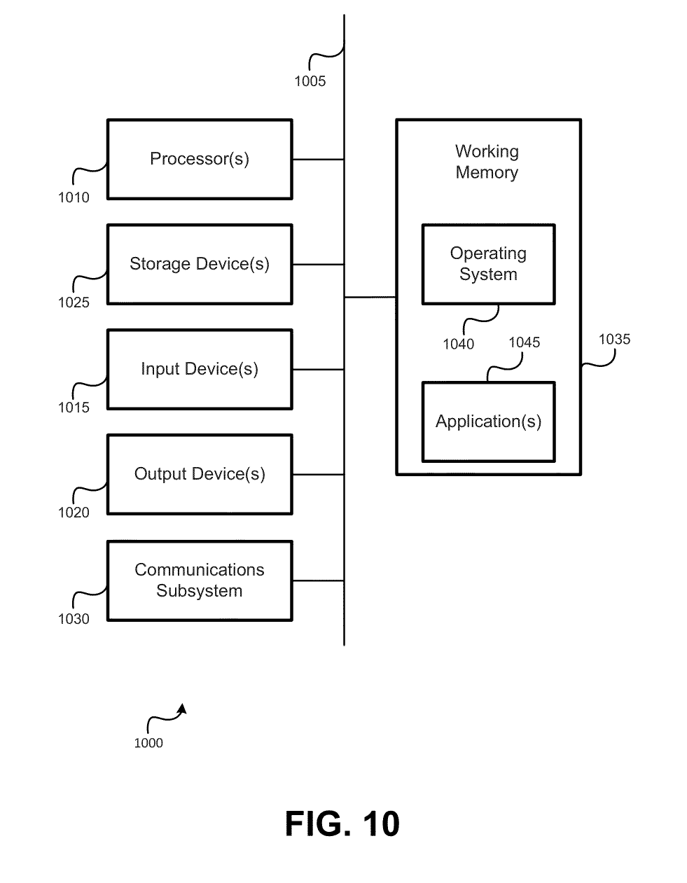

FIG. 1 illustrates an embodiment of a system 100 for executing a composite application. System 100 may include application server system 110, network(s) 120, end user computer systems 130, and third party resources 140. Application server system 110 may be a computer system, such as computer system 1000 of FIG. 10, that hosts one or more applications for end user computer system 130. Application server system 110 may host enterprise resource planning (ERP) software. For example, application server system 110 may host ERP software such as JD EDWARDS ENTERPRISEONE by ORACLE. The application hosted may be a composite application. Within the composite application, multiple application widgets may be executed and presented and/or a database interface may be executed and/or presented. Application server system 110 may host other types of software for end user computer systems 130 also. In some embodiments, application server system 110 may host a composite application, which may be presented to a user via an end user computer system of end user computer systems 130. In other embodiments, the composite application may be executed locally by end user computer systems 130. In some embodiments, a composite application may be presented within a browser being executed by an end user computer system. The content of the composite application may be received from a remote application server system. As such, each application widget and/or database interface may be presented as a frame of a single webpage presented by the browser to the end user.

In some embodiments, application widgets and/or the database interface within the composite application are HTML/XML based. As such, each application widget and/or the database interface may be presented as a separate “webpage” within the composite application. Each of the application widgets and/or the database interface may be resized, moved, opened, closed, and/or hidden (e.g., minimized) within the composite application. As such, while application widgets and/or the database interface may be manipulated within the composite application, a workspace of the composite application may remain open and presented to the user via an end user computer system 130.

Application server system 110 may be in communication with one or more end user computer systems 130 via network 120-1. Network 120-1 may represent a public network, such as the Internet, a private network, such as a corporate local area network, or some combination thereof. Network 120-1 may also include one or more wireless networks, such as a wireless network of a cellular service provider.

While application server system 110 may be a single computer, a distributed computing arrangement may also be possible in which application server system 110 includes multiple computers which function in concert to provide an end user computer system with the composite application.

End user computer systems 130 may each represent a computer system operated by an end user that utilizes software available at the application server system. Each of end user computer systems 130 may be represented by computer system 1000 of FIG. 10. If application server system 110 executed the composite application, an end user may use an end user computer system, such as end user computer system 130-1, to interact with the composite application. In some embodiments, application server system 110 and end user computer system 130 represent the same computer system. As such, an end user may directly interact with the computer system hosting the software with which the end user desires to interact, such as the composite application, through which one or more application widgets and/or a database interface are provided to the user. While FIG. 1 illustrates three end user computer systems 130 as being present, it should be understood that this is for illustration purposes only. While fewer end user computer systems may be present, such as one or two, in some embodiments tens, hundreds, or even possibly thousands of additional end user computer systems may communicate with application server system 110.

Application server system 110 may also communicate with various third party resources 140. Communication between application server system 110 and third party resources 140 may use network 120-2. Network 120-2 may represent the same or a different network from network 120-1. Network 120-2 may include one or more private networks, such as a corporate local area network, one or more public networks, such as the Internet, and/or one or more wireless networks such as a cellular service provider's network.

Third party resources 140 may represent websites. Third party resources 140 may also represent other forms of resources available remotely via network 120-2, such as newsgroups and/or file transfer protocol (ftp) sites. Third party resources 140 may also be accessed directly by end user computer systems 130. Third party resources 140 may represent resources that are operated on behalf of an entity separate from the entity on whose behalf application server system 110 is operated. For example, third party resource 140-1 may represent a commercial website, such as that of a search company, a shipping company, a map provider, etc. Third party resources 140 may each include one or more computer systems, such as computer system 1000 of FIG. 10. While FIG. 1 illustrates three third party resources 140 as being present, it should be understood that this is for illustration purposes only. While fewer third party resources may be present, such as one or two in some embodiments, tens, hundreds, or even possibly thousands of additional third party resources may communicate with application server system 110.

If an end user computer system, such as end user computer system 130-1 attempts to communicate with a third party resource, such as third party resource 140-1, end user computer system 130-1 may use network 120-1 to route a request to third party resource 140-1 via application server system 110 and network 120-1. In some embodiments, end user computer system 130-1 may communicate with third party resource 140-1 via a network, such as network 120-1, without a request being routed by application server system 110. For example, a URL accessed by end user computer system 130-1 may be used to request data from third party resource 140-2 via networks 120.

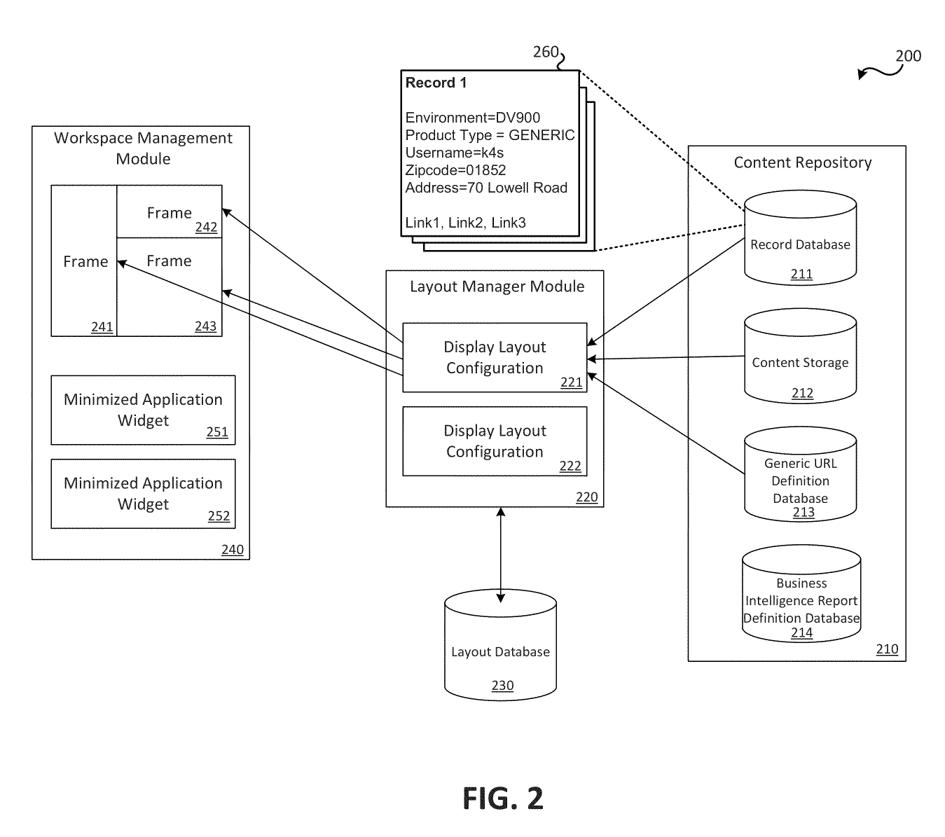

FIG. 2 illustrates an embodiment of a system 200 for presenting multiple display layouts. Each module of system 200 may be executed by an application server system, such as application server system 110 of FIG. 1, and/or by an end user computer system, such as end user computer system 130-2 of end user computer systems 130. Some modules, such as content repository 210 may be maintained remotely from an application server system and/or end user computer systems. Content repository 210 may be spread across multiple storage locations and may be accessible to an application server system and/or end user computer systems. Each module of system 200 may be implemented as software (which may be executed by computer hardware), firmware, and/or hardware. System 200 is not intended to include a representation of every component of a system used to execute and provide a composite application to an end user. Rather, system 200 represents a block diagram of modules relevant to how the composite application is presented to the user. For example, the modules of system 200 may affect the display layout of how application widgets and/or a database interface are presented to a user via a display device of an end user computer system.

System 200 may include content repository 210, layout manager module 220, layout database 230, and workspace management module 240. Content repository 210 may represent computer-readable storage (e.g., on a non-transitory computer-readable storage medium) that stores data which may be presented, directly or indirectly, to a user via a database interface and/or application widget While content repository 210 contains four databases, it should be understood that such databases are exemplary only. Fewer or more databases may be accessible. Record database 211 represents a database from which records may be retrieved and presented to a user via a database interface. For example, a user may be presented with a table which allows a user to select individual records in the database.

Record database 211 may contain various records. As an example, records within record database 211 may be information for an electronic contact list. If an application server system hosts ERP software (which may be in the form of a composite application), record database 211 may contain information such as orders and/or inventory of a business entity that operates the application server system.

For an electronic contact list, various records, such as record 260 may be present. While only record 260 is illustrated in FIG. 2, it should be understood that tens, hundreds, or thousands of records may be present. Record 260 contains various pieces of information related to a particular entity. In record 260, username “k4s” is linked with a zip code (01852) and an address (70 Lowell Road). This record also contains three links (link1, link2, and link3), which may be generic URLs/URIs generated based on a generic URL/URI definition and data present within the database record.

Content storage 212 may store various media data that may be presented to the user via the composite application. For example, content storage 212 may contain text, graphics, video, maps, etc. which may be accessed based on a record selected by a user via a database interface within the composite application.

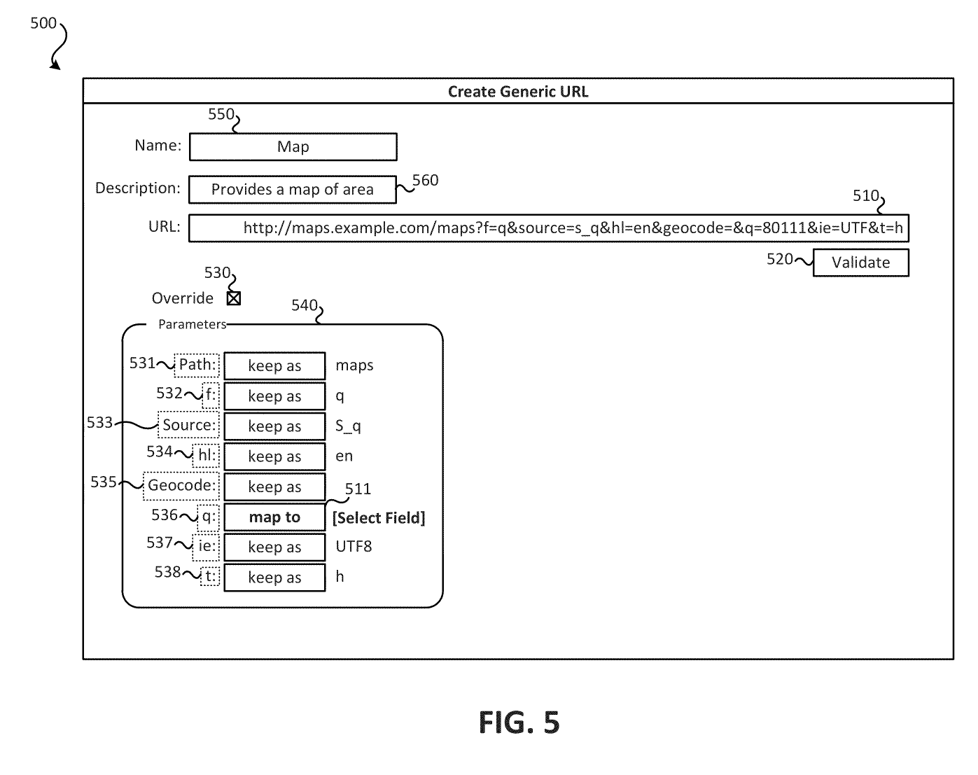

Generic URL definition database 213 may represent a repository of generic URLs and/or URIs that are defined by users and may be generated and accessed based on a database record selected by a user. For example, a user may provide a URL and indicate one or more parameters within the URL which may be modified based on content of a database record. The generic URL which indicates how the URL is mapped to the database record may be stored as part of generic URL definition database 213. A generic URL may be used to access a resource from a third-party (e.g., a website that provides shipment tracking information or maps) or from a source on a corporate intranet. Generic URL definition database 213 may apply, more generally, to URIs. Further details regarding the creation and use of generic URLs are detailed in relations to FIGS. 5-7.

Business intelligence (BI) report definition database 214 may represent a repository of definitions of BI reports that are defined by users and may be generated and accessed based on a database record selected by a user. For example, a user may provide an indication of how summary data should be generated for each record and what information should be retrieved from other sources (e.g., content storage 212) for a BI report. Depending on the database record selected, the BI report presented by the composite application may be created to correspond to the selected database record.

Layout manager module 220 may manage how the database interface and/or the applications widgets presented within the composite application are presented to a user via a display device (e.g., computer monitor, mobile device screen, tablet screen, television, projector, laptop screen) to the end user. Layout manager module 220 may manage how frames are presented within a web browser. Layout manager module 220 may determine the location and sizing (e.g., maximized, minimized, other size) of the database interface and/or application widgets presented within the composite application. The composite application may be presented to the user as part of a graphical user interface in the form of a window. Within the window may be frames. Each frame, which may be dragged and dropped to reposition and/or resize the frame, may be manipulated individually. These frames may be created based on HTML and/or XML code.

An “application widget” refers to an application that may be run within a composite application. Information (e.g., text, graphics) presented within an application widget may be based on a selection made by a user in another interface within the composite application, such as a database interface. Each application widget may be logically separate from each other application widget. As such, an application widget may be defined as a generic piece of software code that is portable and is intended to be implemented in various instances within the composite application. Each application widget within a composite application may be presented in a frame dedicated to one application widget.

Layout manager module 220 may permit a user to select a display layout configuration for use in organizing application widget(s) and database interface(s) within a composite application being presented to a user via a user computer system. Via layout manager module 220, a user may select a display layout configuration which may affect: the sizing of displayed application widgets; the location of displayed application widgets; which application widgets are executed, displayed, and/or minimized; the sizing of a database interface; the location of the database interface; and/or whether the database interface is minimized. In the illustrated embodiment of system 200, display layout configuration 221 is used to determine which application widgets are executed and displayed along with the database interface. Display layout configuration 221 may be a default display layout configuration, may have been selected by the user, or may have been defined by the user. According to display layout configuration 221, three frames are presented (frame 241, frame 242, and frame 243).

Further, in some embodiments, the display layout configuration may be selected based on a type of database record accessed in the composite application. For example, a customer account record that is accessed may result in a different layout and/or one or more different widgets being executed and/or presented than if an employee account record is accessed via the database interface.

Each of frames 241, 242, and 243 are within a workspace management module 240. Workspace management module 240 may represent the presentation region managed by the composite application. In the illustration of system 200, display layout configuration 221 defines that frame 241 occupies the left side of the composite application's workspace management module 240, while frame 242 occupies the top of the remainder of the composite application's workspace management module 240 and frame 243 occupies the remainder of the composite application's workspace management module 240. A user may reposition each of frames 241, 242, and 243 by dragging and dropping the frames and/or expanding/contracting the frames as desired. Each of frames 241, 242, and 243 may correspond to a different application widget or the database interface. For instance, frame 242 may present a database interface allowing access to database records from record database 211. Frame 241 may present information accessed from a third-party resource according to a generic URL retrieved from generic URL definition database 213. The generic URL may be mapped to data present in a record selected by a user within frame 242, which corresponds to the database interface. Frame 243 may correspond to content related to the selected record within the database interface of frame 242. For instance, a video may be retrieved from content storage 212 that corresponds to the selected record and may be presented to the user via frame 243.

Further, workspace management module 240 may manage one or more application widgets (and/or a database interface) that are being executed but are not currently displayed within the composite application. In the illustrated embodiment of system 200, according to display layout configuration 221, application widget 251 and application widget 252 are currently being executed, but are hidden (e.g., minimized), thus requiring a user to access (e.g., click on) the hidden application widget before interacting with the application widget. A graphical representation of a hidden application widget, such as an icon, may be displayed within workspace management module 240 which allows the user to access minimized application widgets 251 and 252. If the user modifies the layout of workspace management module 240, the modified layout may be saved by the user as display layout configuration 221 or as a new display layout configuration. In some embodiments, an application widget represented by an icon may be dragged onto a frame displayed within a content workspace; the minimized application widget may be expanded to occupy some or all of the region of the frame.

Display layout configurations may be stored to a layout database 230. Display layout configurations within layout database 230 may be maintained separately for individual users. As such, a user may be permitted to create his own display layout configurations. In some embodiments, some or all display layout configurations are made public, thus allowing a user to access a display layout configuration created by another user. A user may have the option to make a display layout configuration public or private. A display layout configuration may be assigned a title by a user, thus allowing users a quick description of the display layout configuration. For instance, a display layout configuration named “big map view” may clue the user in to the display layout configuration being useful for viewing a map of the geographic region associated with the selected record within the database interface.

In FIG. 2, a second display layout configuration is present: display layout configuration 222. Display layout configuration 222 is not currently being used for setting the display characteristics within workspace management module 240. However, display layout configuration 222 may be selected by the user, thus resulting in a change in: which application widgets are presented, the layout of the application widgets, the sizing of the application widgets, the sizing of a database interface, the location of the database interface, which database interface is presented, and/or which application widgets/database interfaces are minimized and displayed.

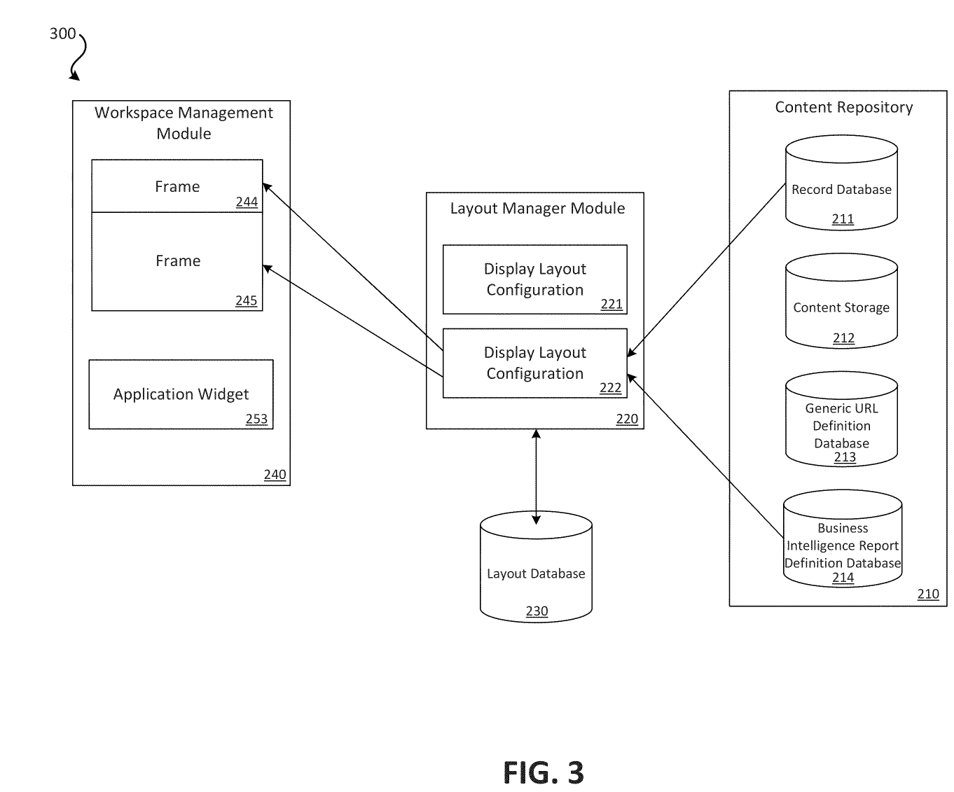

FIG. 3, similar to FIG. 2, illustrates an embodiment of a system 300 for presenting multiple display layouts. Each module of system 300 may be implemented as software (which may be executed by computer hardware), firmware, and/or hardware. System 300 is not intended to include a representation of every component of a system used to execute and provide a composite application to an end user. Rather, system 300 represents a block diagram of modules relevant to how the composite application is presented to the user. System 300 may represent an embodiment of system 200 of FIG. 2. System 300 may represent system 200 when a user has selected display layout configuration 222 instead of display layout configuration 221.

When display layout configuration 222 is activated by a user, the presentation of frames within workspace management module 240 may be changed. In the illustrated embodiment of workspace management module 240, frame 244 and frame 245 may be present. In some embodiments, frames 244 and 245 may correspond to some of the same application widgets and/or database interfaces as frames 241, 242, and 243. For instance, in some embodiments, frame 244 may present the same application widget as frame 241 of FIG. 2, but with the application widget moved to a different location and with a different display size. Frames 244 and 245 may correspond to different application widgets and/or database interfaces than frames 241 and 242 of FIG. 1. Therefore, by selecting display layout configuration 222, the application widgets and/or database interfaces being executed may be modified.

In the illustrated embodiment of system 300, record database 211 is accessed to provide data for a database interface presented in frame 244. BI report definition database 214 is accessed to create a BI report presented for the record selected within the database interface, wherein the BI report for the selected report is presented in frame 245.

The size and position of frames 244 and 245 differ from the size and position of frames 241, 242, and 243 of FIG. 2. These sizes and positions are based on the display layout configuration loaded in layout manager module 220. For example, in system 300, frame 244 occupies approximately the top third of the display region within workspace management module 240 while frame 245 occupies the bottom third. Display layout configuration 222 may be a default display layout configuration or a user-defined display layout configuration.

In system 200, two application widgets (251, 252) were executed within workspace management module 240 in a minimized mode and were available for access by a user. When display layout configuration 222 was selected by the user within layout manager module 220, application widgets 251 and 252 may stop being executed. Alternatively, one or more of application widgets 251 and 252 may correspond to frame 244 and/or frame 245 of FIG. 3. Application widget 253 of system 300 may represent an application widget which was previously not executed by system 200 or may have been executed and presented via frame 241, frame 242, or frame 243.

As a user activates minimized application widgets, such as application widget 253, it may be displayed within workspace management module 240 of the composite application in a new frame. The activated application widget 253 may cover or otherwise displace a frame already displayed within workspace management module 240. The user may choose to minimize an application widget or database interface presented in some other frame, which would result in the minimized application widget or database interface being hidden within workspace management module 240.

Regardless of which display layout configuration is activated by the user, the user may be permitted to rearrange, resize, add, and/or close frames within workspace management module 240. The user may be permitted to save the modified layout as the currently active display layout configuration or as a new display layout configuration. The user may be permitted to designate a name for the display layout configuration and/or specify whether the new display layout configuration is to be public (and accessible by other users) or private.

Layout manager module 220 is illustrated as having two display layout configurations 221 and 222 with the layout manager module 220 in communication with a layout database 230. It should be understood that the illustration of two display layout configurations within layout manager module 220 is for exemplary purposes only: layout manager module 220 may have a single active display layout configuration at a time and may access another display layout configuration from layout database 230 based on a selection by a user. Further, the number and layout of frames presented as part of workspace management module 240 in FIGS. 2 and 3 is exemplary only. The number and arrangement of frames may vary according to the how a user has dragged and dropped frame(s), the active application widgets, the active database interface(s), and/or the active display layout configuration.

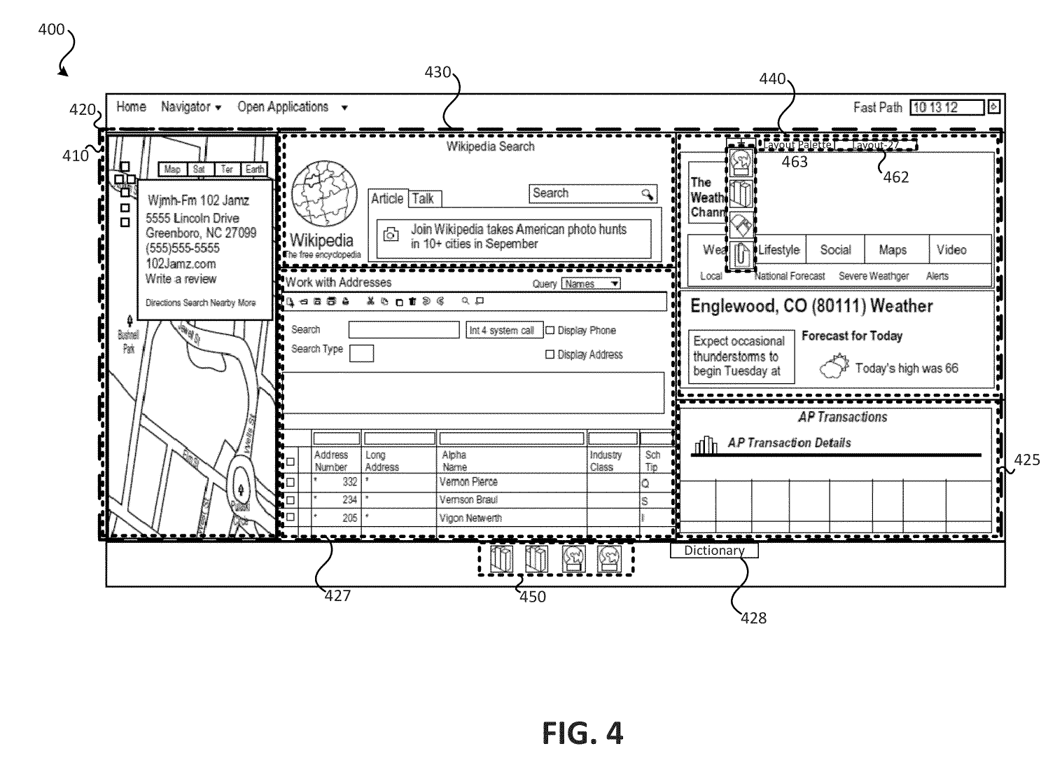

FIG. 4 illustrates an embodiment of composite application 400. Composite application 400 may provide a framework for presenting dynamic contextual content, including application widgets and database interfaces. In some embodiments, the composite application is presented within a browser window. As such, each application widget and database interface of the composite application is presented within dedicated frames presented simultaneously by the browser. While the code to execute each application widget and/or database interface may be separate and may function independently of the composite application, the composite application may allow multiple application widgets and/or database interfaces to be presented simultaneously by a browser and may allow a user to resize and/or reposition frames. For an application widget related to a generic URL or a business intelligence report, a portion of an URL or filter (for a business intelligence report) may be replaced with a particular runtime value that corresponds to a selected database record selected or some form of user input. In response to the database record being selected or other user input, the URL request or BI filter used to create the BI report may be created, executed, and the resulting content presented. Therefore, as the user interacts with the composite application, the application widgets are updated with the relevant content. Further, a user may save and load various display layout configurations that identify which application widgets and database interfaces are presented and the layout for the presentation to the end user of such application widgets and database interfaces within the composite application (which may be presented by the browser). Composite application 400 of FIG. 4 may be created and output for presentation by system 100, system 200, and/or system 300 of FIGS. 1-3, respectively.

In embodiments detailed herein, the location of application widgets and/or database interfaces may be customized by both the developer (e.g., set as a default for users) and/or by the end user. In FIG. 4, frame 410 presents an application widget which displays a map based on a generic URL. The generic URL may have been previously defined such that one or more parameters within the generic URL are linked to data present within a record. The record may be selected via a different frame within composite application 400.

The location of the record of the database being displayed may be customized by the developer and/or the end user. In the illustrated embodiment of composite application 400, the frame containing database interface 427 may display database records, from which a user may be permitted to select. Database interface 427 may be repositioned and resized by the end user and/or developer via a drag and drop arrangement within the composite application. Content workspace 420 represents the overall working area in which application widgets and/or database interfaces can be customized by the end user and/or developer. Content workspace 420 may correspond to workspace management module 240 of FIGS. 2 and 3. Content workspace 420 may present a database interface (such as an Oracle® Enterprise One form) including a selected database record and all the currently-displayed related contextual content presented as application widgets (e.g., in frame 410, frame 430, and frame 440). Based on the database record selected within database interface 427, the contextual content (e.g., application widgets) presented in other regions of the content workspace 420 in the browser may be modified. For example, if another record is selected, a new URI or URL created from a generic URI or generic URL associated with frame 410 may be created and a new map may be displayed in the frame 410.

In addition to frame 410, frame 430 and frame 440 may present content retrieved from a resource (which may be a third-party resource) based on a generic URI or URL. Based on a record selected in database interface 427, each generic URL (or URI) may be used to create a URL (or URI) wherein one or more parameters within the created URL or URI is based on data present in the selected database record. The URL/URI may be used to retrieve content. For example, referring to frame 430, a Wikipedia® article on the entity indicated in a selected record within the database interface may be retrieved and presented. Referring to frame 440, the weather may be retried for an address indicated in the selected record within the database interface. Based on the display layout settings either created or selected by the user, frames are presented within content workspace 420. A user may access layout palette 462 to load or save a display layout configuration. This display layout configuration may indicate: 1) which application widget(s) are executed and displayed in a frame; 2) which application widget(s) are executed and minimized; 3) the location of frames for application widget(s); 4) the size of frames for application widget(s); 5) which database interface(s) are executed and displayed in a frame; 6) which database interface(s) are executed and minimized; 7) the location of frames for database interface(s); and/or 8) the size of frames for database interface(s). These display layout configurations may have been assigned as a default by the developer or as a customization by the end user. Via layout palette 462 a user may select to load a display layout configuration previously created by the user or by some other user. The user may modify a display layout configuration currently being used for display settings by dragging frames, expanding/collapsing borders of frames, minimizing frames, un-minimizing frames, closing frames, and/or opening new frames.

When a new application widget is being added to a content workspace from layout palette 462, a user may drag a graphical representation (e.g., icon) of the new application widget to a location on the content workspace where the user desires the new application widget to be displayed. As the graphical representation is dragged, a shaded area, or some other graphical representation may be displayed showing where the new frame is to be placed. As the location to which the graphical representation is dragged changes, the location where the new frame is to be placed may be changed. The dimensions of the frame for the new application widget may have minimum and/or maximum values defined by the creator of the application widget. In some embodiments, all available space within a content workspace is occupied by frames. As such, as frames are moved, minimized, and/or resized, other frames may be moved, minimized, and/or resized to fill any space within the content workspace unoccupied by a frame.

Type palette 463 may permit a user to define a new application widget. Type palette 463 may permit a generic URL/URI to be created and/or an BI report to be created. If a user desires to create a generic URL/URI and indicates as such in type palette 463, the user may be presented with an interface that permits the user to define the generic URL/URI. After creation, the user may be permitted to add a frame to content workspace 420 for the application widget associated with the new generic URL/URI. In some embodiments, via type palette 463, a user may be permitted to select a previously-defined URL/URI to add as an application widget to content workspace 420. Such a previously-defined URL/URI may have been defined by the user or by some other user.

Type palette 463 may also permit a BI report to be created. If a user desires to create a BI report and indicates as such in type palette 463, the user may be presented with an interface that permits the user to define the BI report. The BI report may be defined to present various data (e.g., calculations, reformatting information, graphed information) regarding the selected record within the database report. For example, a BI report may present information on the total value of orders a company associated with the selected record in the database interface has made over the previous six months. After creation, the user may be permitted to add a frame to content workspace 420 for the application widget associated with the new BI report. In some embodiments, via type palette 463, a user may be permitted to select a previously-defined BI report to add as an application widget to content workspace 420. Such a previously-defined BI report may have been defined by the user or by some other user.

Content manager 450 may present an inventory of various types of application widgets which may be used to create and display content. As such, various application widgets which may be based on generic URLs or URIs, BI reports, and/or database interfaces may be indicated by an icon or other graphical representation in content manager 450. Elements from content manager 450 may be accessed by the end user by interacting with the icons or graphical representation. For example, an element of content manager 450 may be “opened” for use in defining a new application widget.

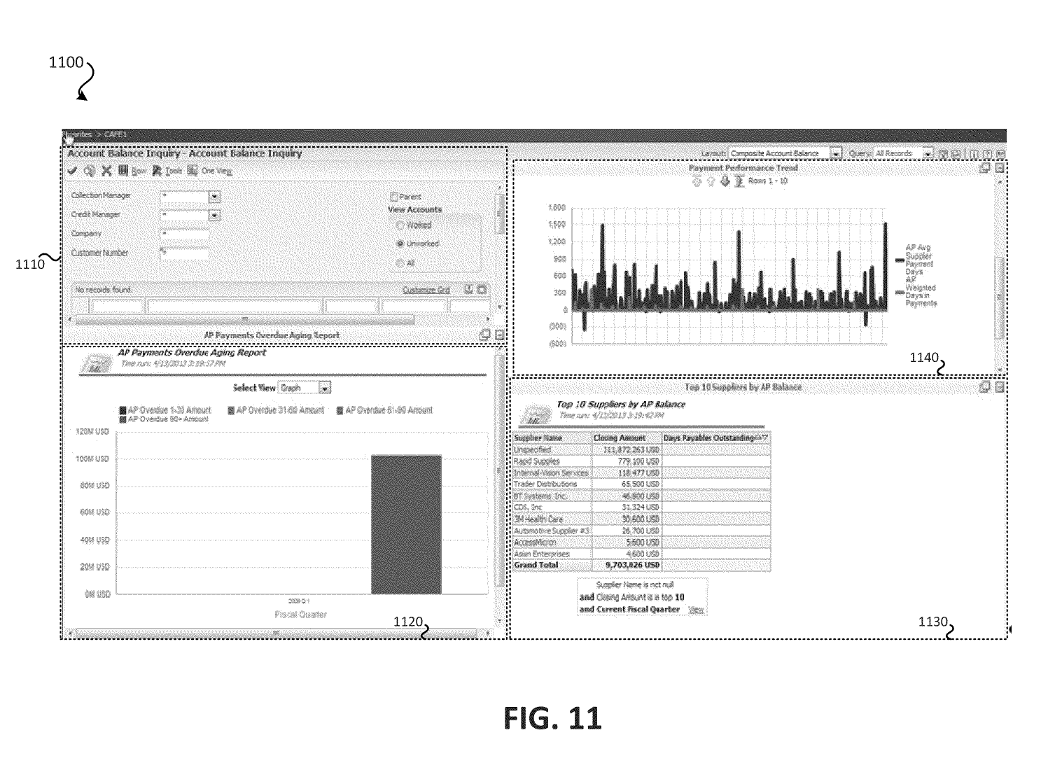

As an additional example, FIG. 11 illustrates a screenshot of an embodiment of composite application 1100. In composite application 1100, four possible BI reports are illustrated. These BI reports, BI reports 1110, 1120, 1130, and 1140, which are each separate application widgets of composite application 1100 and are each reports which may be created based on filters assigned to particular application widgets. For instance, BI report 1140 may be a graph that is based on data associated with a record which is selected (e.g., in a database interface not currently displayed). In BI report 1110, a query is run for a particular type of record related to a selected record (for example, a customer record may be selected, with the search in the BI report being performed for overdue payments. Each application widget in composite application 1100 may be rearranged in accordance with different layouts.

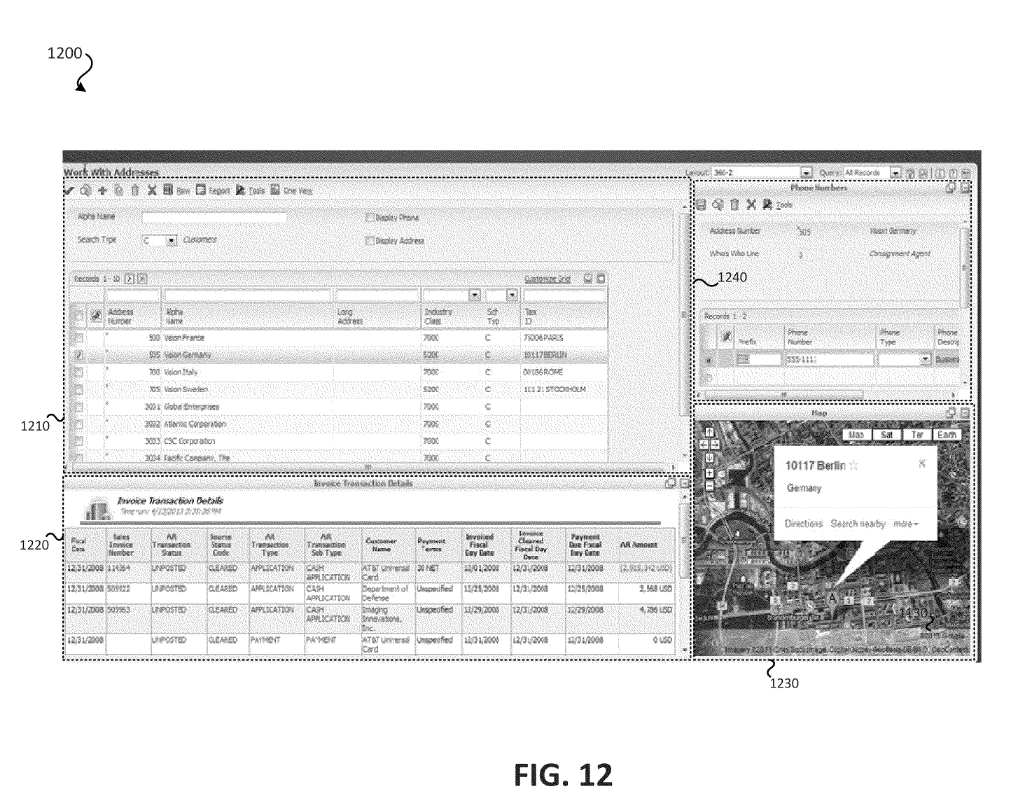

FIG. 12 illustrates a screenshot of another embodiment of composite application 1200. In composite application 1200, database interface 1210 allows a user to select a record. BI report 1220 presents filtered data that involves the selected database record as an application widget. The filter used to create BI report 1220 may have been previously defined by the user or some other user. Generic URL widget 1230 may be an application widget that presents a map based on the selected record in database interface 1210. The generic URL widget 1230 may create a specific URL based on a generic URL defined by the user or some other user. BI report 1240 may present various phone numbers related to the selected record in database interface 1210. Each application widget in composite application 1200 may be rearranged in accordance with different layouts.

FIGS. 11 and 12 provide two additional examples of composite applications and are merely exemplary. The use or arrangement of the specific types of application widgets or the particular presented layout is for illustration purposes only.

As previously detailed, type palette 463 may permit a user to create a new application widget. Type palette 463 may permit a generic URL/URI to be created. If a user desires to create a generic URL/URI and indicates as such in type palette 463, the user may be presented with an interface that permits the user to define the generic URL/URI such as indicated in FIG. 5. FIG. 5 illustrates an embodiment of an interface 500 for creating a generic universal resource indicator (and/or URL). An end user or developer, via a computer system, such as an end user computer system of end user computer systems 130 or application server system 110 of FIG. 1, may be presented with interface 500. For example, interface 500 may be a web-based interface that is hosted by application server system 110 and presented to an end user or administrator (or some other form of user) via an end user computer system of end user computer system 130. A user may desire a generic URI, such as a URL, be created from a URI which may be provided in link input 510 of FIG. 5: “http://maps.example.com/maps?f-=q&source=s_q&h1=en&geocode=&q=80111&ie=UTF&t=h.” The URL present in link input 510 contains several parameters. Following a user providing a URL (or URI) into link input 510, validate input 520 may be selected. This may validate the resource identified by the URL. Validating the URL may include loading the URL such that the resource identified by the URL is presented to the user. In some embodiments, the loaded resource is not displayed to the user. In some embodiments, it is determined whether a frame breaker is present in the code of the resource linked to the URL. If so, the URL may not be able to be displayed in a frame. This may render the resource ineligible for certain uses (such as being displayed in a portion of a web browser) while other information, such as an ERP database interface, is displayed in the remainder.

The parameters present in the URL provided to link input 510 may be identified. These parameters may be displayed to the user in parameters region 540. If a user desires to create a generic URL from the URL provided in link input 510, the user may select override 530. Selecting override 530 may permit the user to view and/or modify parameters of the provided URL. In the embodiment of FIG. 5, the URL has the following parameters: path 531, “f″ 532, source 533, “h1” 534, geocode 535, “q” 536, “ie” 537, and “t” 538. A user may have the opportunity to modify one or more of these parameters for the generic URI. Parameters may be kept as the corresponding value present in the URL provided in link input 510. For example, referring to parameter “q” 536, the user may determine that this parameter is linked to a zip code that affects what map (or what portion of the same map) is returned when the resource is requested. As such, the user may wish to link this parameter to some variable, such that as the variable changes, one or more attributes of the resource, as requested, changes.

In the example of interface 500, the URL provided by the user to link input 510 is a link to a map provided by a third party resource of the area of zip code 80111. The user may desire to create a generic URL that modifies the “q” 536 (the zip code) parameter such that the generic URL can be used to generate an URL that loads a map of other zip codes depending on the value of the variable. In name input 550, the user may provide a name to link with the generic URL. In description input 560, the user may provide a description to link with the generic URL.

It should be understood that the URL, parameters, and the parameter(s) desired to be modified by the user are for example purposes only. The parameters presented to the user via parameters region 540 may vary based on the URL provided in link input 510.

In interface 500 of FIG. 5 following the user selecting to modify parameter “q” 536, the user may use modification selector 511 to indicate that the user desires to use a value other than the original value present in the URL provided in link input 510. Modification selector 511 may have several options: “keep as,” “map to,” and “set to” are three possible options.

If modification selector 511 is set to “keep as” this may mean that the value of the parameter is maintained from the originally supplied URL provided in link input 510. If modification selector 511 is set to “set to,” a constant value may be provided by the user that is used in the generic URL. If modification selector 511 is set to “map to,” the user may select or provide a variable that the parameter is mapped to. For example, in the instance of a database, the variable may be a particular field present in some or all of the records of the database. Therefore, depending on the record currently selected in a database interface, a field from that record will be mapped (with or without modification) to the parameter of the generic URL. In interface 500, after setting modification selector 511 to “map to,” the user may be prompted to select a field that the parameter is to be linked to.

It should be understood that the language of “keep as,” “set to,” and “map to” is intended to be exemplary. Other language (or symbols) can be used to provide a user with similar options.

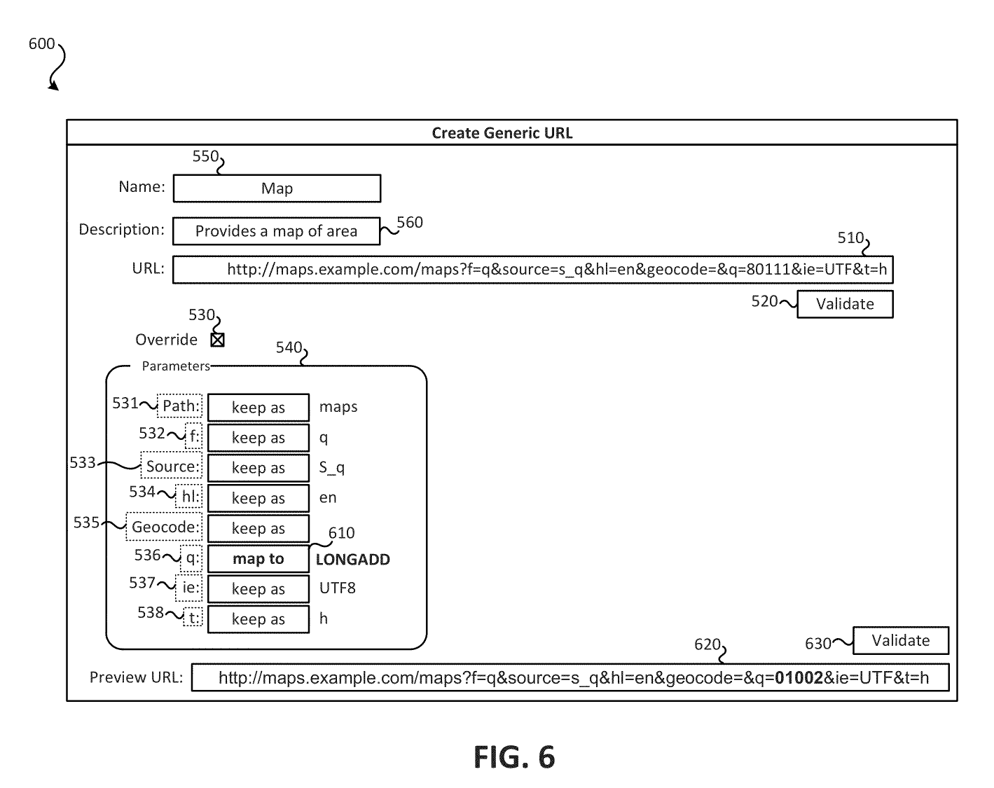

FIG. 6 illustrates another embodiment of an interface 600 for creating a generic universal resource indicator. Interface 600 represents interface 500 of FIG. 5 following a user selecting the field to which to map parameter “q” 536. In interface 600, the user has selected a variable called “LONGADD.” The variable may be a field present in one or more records of a database. As such, depending on the value of the field corresponding to LONGADD in a particular record, a specific URL can be created using the generic URL to retrieve a resource using information from the particular record.

Preview URL display 620 may illustrate a generic URL created using the URL provided in link input 510 in conjunction with the modified parameters in parameters region 540. As such, in the example of interface 600, because parameter “q” 536 has been mapped to variable “LONGADD,” the value of “q” in preview URL display 620 is replaced with the value of LONGADD (which, in the example of FIG. 6, is illustrated as 01002). Validate input 630 may allow a user to determine whether the generic URL is expected to be functional. Selecting validate input 630 may result in a determination of whether the resource linked with the generic URL contains a frame breaker. Also, the URL may be loaded for various values of, in this case, LONGADD to determine whether modifying the value of the parameter “q” 536 yields valid URLs.

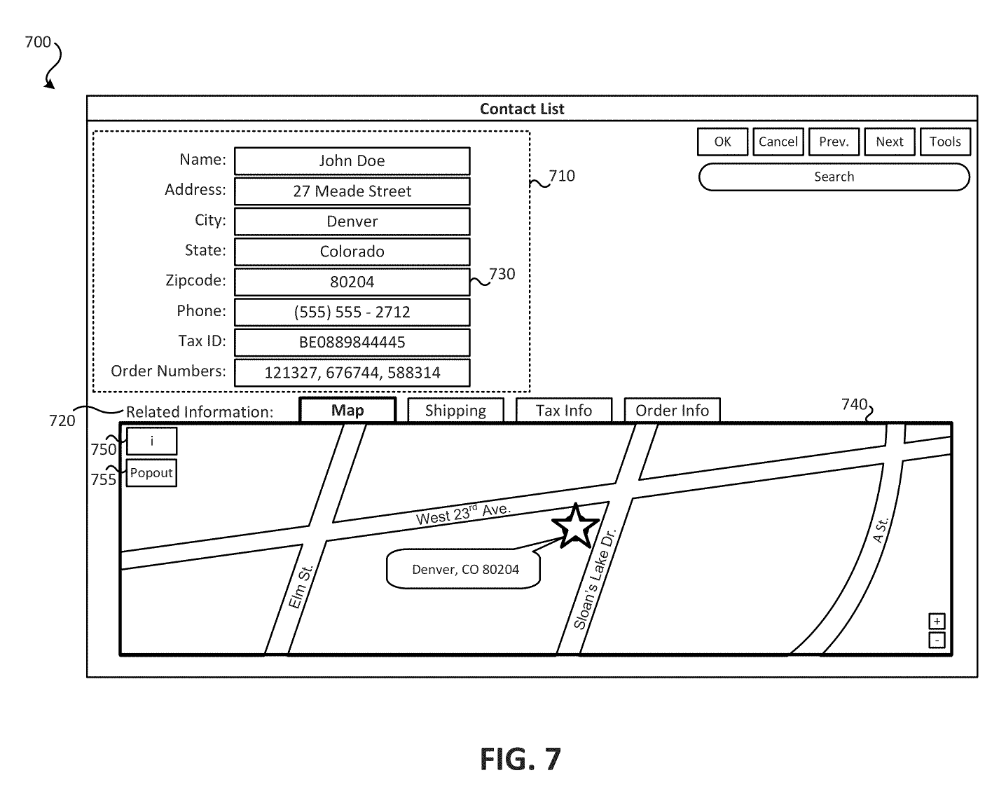

Once a generic URI or URL has been created, the generic URL may be used in conjunction with database records to contextualize a resource for the loaded (e.g., displayed) record. FIG. 7 illustrates an embodiment of an interface 700 for using a generic URL to retrieve a resource contextualized for a selected record of a database. Interface 700 illustrates an embodiment of a record from an electronic contact list. This contact list may be hosted by an application server system and accessed by an end user computer. In the embodiment of interface 700, address information 710 may represent biographical information for a particular entity, such as a supplier, indicated in a database record. In this embodiment, the name, address, city, state, zip code, phone number, tax identification, and order numbers are listed in each record. Referring to FIG. 2, this record of the electronic contact list may represent a record of record database 211. While interface 700 only illustrates one record, many hundreds or thousands of other address records may be loaded within interface 700. Once the generic URL has been defined, the generic URL may be used in another interface, such as in content workspace 420 (which may be presented in a web browser) to present content in a frame linked with an associated selected database record.

Toolbar 720, entitled “Related Information,” may provide a user with access to resources that have been retrieved using generic URLs. Referring back to FIG. 6, a generic URL was created having a generic parameter “LONGADD” as the “q” parameter of the URL provided in link input 510 that is linked with the corresponding record fields serving as the variable. The generic URL presented in preview URL display 620 may be used to create the map presented in display window 740 of interface 700. The LONGADD variable is the zip code field of the records of the database. For the record displayed in interface 700, the value present in zip code field 730 is 80204. As such, the value of LONGADD for this record is 80204. Therefore, a URL specific to the displayed record is created using 80204 as the value of LONGADD in the generic URL. In this instance, the URL would be: http://maps.-example.com/maps?f=q&source=s_q&h1=en&geocode=&q=80204&ie=UTF&t=h. This URL specific to the displayed record is used to request the resource. Attributes of the resource, as retrieved, are contextualized to the displayed record by displaying a map centered on the zip code present in zip code field 730. If zip code field 730 is updated, the URL created from the generic URL may also be updated, resulting in the resource being contextualized to the new URL. Information selector 750 may allow the user to view the link as created from the generic URL and/or may allow the user to view the generic URL. Pop-out selector 755 may allow the user to load the map in a separate window (e.g., not a frame of interface 700).

FIGS. 5-7 illustrate various embodiments of interfaces for creating generic URIs and URLs. FIG. 5 illustrates an embodiment to use generic URIs or URLs to retrieve a resource contextualized for a record of a database. It should be understood that each of these interfaces is merely exemplary. The presentation of the various fields, windows, and the use of an electronic contact list are merely exemplary. Similar information may be rearranged, presented over multiple interfaces, or combined with other interfaces. Other forms of databases may be used. In some embodiments, generic URIs and URLs may be used in conjunction with data structures other than records of databases. Further, the use of a generic URL to create a generic link for a map is intended to merely be exemplary. Generic URLs and URIs may be used to retrieve contextualized resources from other sources that use parameters in URLs or URIs.

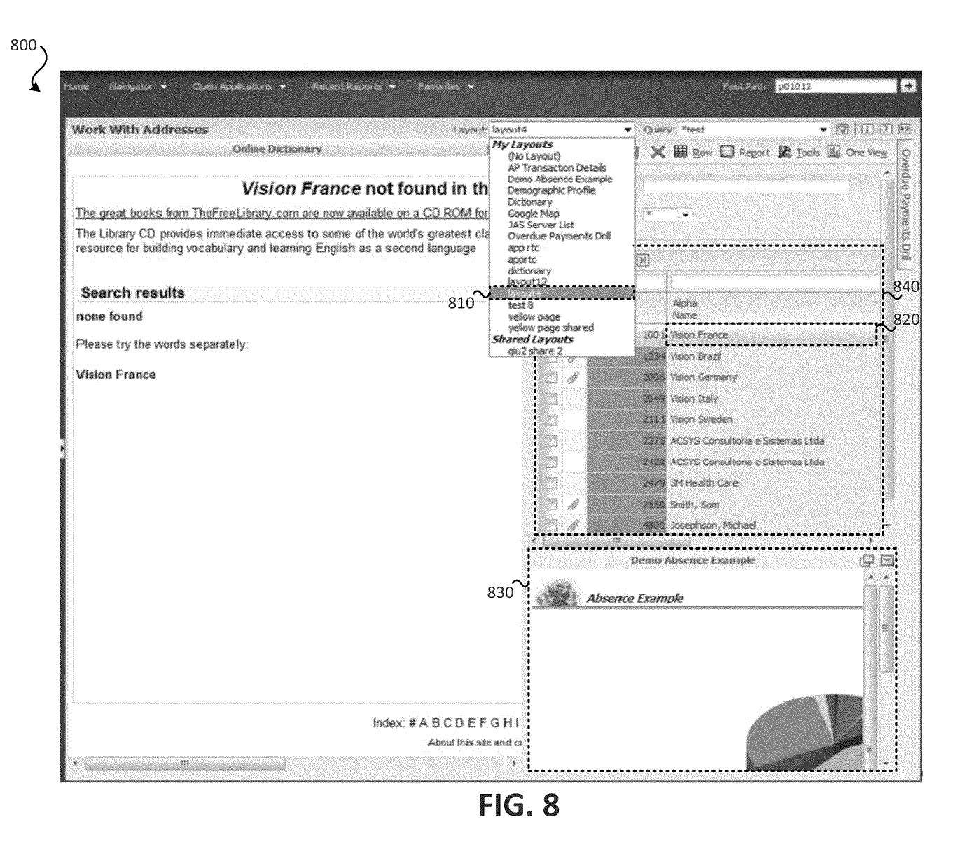

FIG. 8 illustrates an embodiment of a composite application 800. In some embodiments, composite application 800 is presented within a browser window. As such, each application widget and database interface of the composite application, is presented within dedicated frames presented simultaneously by the browser. While the code to execute each application widget and/or database interface may be separate and may execute independently of the composite application, the composite application may allow multiple application widgets and/or database interfaces to be presented simultaneously by a browser and may allow a user to resize and/or reposition frames. Further, a user may save and load various display layout configurations that identify which application widgets and database interfaces are presented and the layout for the presentation to the end user of such application widgets and database interfaces within the composite application (which may be presented by the browser). Composite application 800 of FIG. 8 may be created and output for presentation by system 100, system 200, and/or system 300 of FIGS. 1-3, respectively.

In composite application 800, a user has selected layout 810 from a pull-down menu within composite application 800. Such selection may result in BI report 830 being positioned in a frame at the bottom-right of composite application 800 with database interface 840 being positioned in a frame above BI report 830. In composite application 800, BI report 830 has been defined to create a pie chart based on data present within the selected database record. Record 820 is currently selected within database interface 840, which affects the data presented within BI report 830. Selection of a different layout may result in the application widgets and/or database interface being repositioned, closed, and/or minimized. Additional application widgets and/or database interfaces may be executed. and presented within frames of composite application 800.

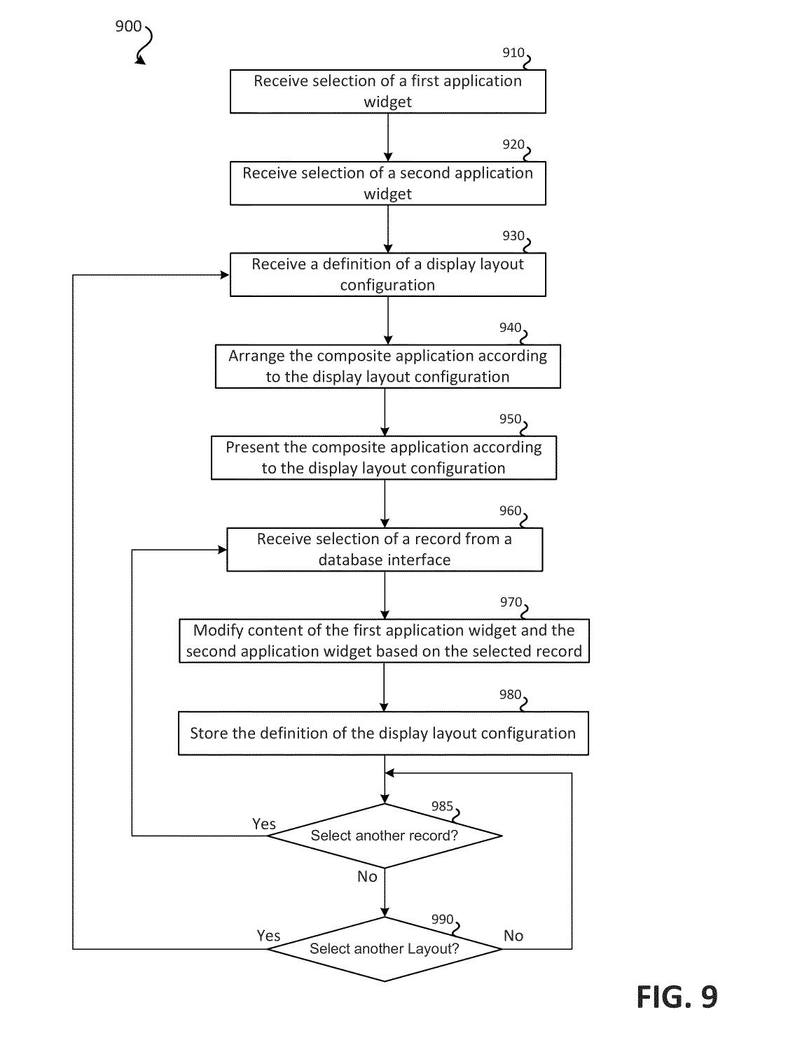

Various methods may be performed using the systems and interfaces previously detailed. FIG. 9 illustrates an embodiment of a method 900 for managing a layout within a composite application. Method 900 may be performed using the systems of FIGS. 1-3 or similar systems. Method 900 may involve the use of interfaces similar to those presented in FIGS. 4-7. Method 900 may be performed using one or more computer systems. As such, means for performing each step of method 900 involve one or more instances of computer components and/or components of systems detailed in relation to systems 100 and 200 of FIGS. 1 and 2, respectively.

At step 910, a user may select a first application widget that the user desires to have presented in relation to a selected database record within the composite application. The composite application may present one or more database interfaces that allow a user to view and/or interact with database records present within the database. The first application widget may be based on a generic URL/URI, a BI report, a dashboard (e.g., a summary of critical business data that may or may not vary based on a record selected) or some other form of application widget. Referring to FIG. 4, the user may select the type of the first application widget to be presented via layout palette 462. The user may define the application widget himself or may use a previously created definition for the application widget. The application widget may be configured to be presented within a dedicated frame within a browser, such as a web browser.

At step 920, the user may select a second application widget that the user desires to have presented in relation to a selected database record within the composite application. The second application widget may be based on a generic URL/URI, a BI report, or some other form of application widget. Therefore, following step 920, two generic URL/URIs may be selected, two BI reports may be selected, or a BI report and a generic URL/URI may be selected for the application widgets to be presented as contextual content. Referring to FIG. 4, the user may select the type of the second application widget via layout palette 462. The user may define the application widget himself or may use a previously created definition for the application widget. The application widget may be configured to be presented within a dedicated frame within a browser, such as a web browser.

At step 930, the user may provide a definition of a display layout configuration according to how a composite application presenting at least the two application widgets and a database interface are to be presented. In some embodiments, the user may load a predefined display layout configuration. The predefined layout configuration may define sizing and layout for the first application widget, the second application widget, and the database interface. In some embodiments, rather than selecting application widgets at steps 910 and 920, selection of the display layout configuration at step 930 specifies which application widgets are to be executed and presented within a composite application (which may be presented as a web page in a web browser to the user). In some embodiments, the user may define the display layout configuration by dragging, dropping, resizing, minimizing, maximizing, or otherwise manipulating frames for the first application widget, the second application widget, and/or the database at step 930. As the user defines the layout configuration, step 940 may be performed such that the user sees the result of his manipulation of the frames of the application widgets and/or database interface. In some embodiments, a user may load a predefined display layout configuration, then may modify the display layout configuration by dragging, dropping, resizing, minimizing, maximizing, or otherwise manipulating frames.

At step 940, if the user has selected a predefined (e.g., previously saved during another session in the composite application) display layout configuration, the database interface and application widgets within the composite application may be arranged according to the display layout configuration. At step 950, the composite application may be presented according to the display layout configuration selected and/or defined by the user.

At step 960, the user may select a database record within the database interface of the composite application, wherein the database record is presented via a first frame of the composite application. The record may be selected by a user clicking or otherwise providing input that results in a particular record being selected. At step 970, the content of the first application widget and/or the second application widget, which are presented via second and third frames of the composite application, may be modified. The content of the first application widget and/or the second application widget may be at least partially defined based on data present within the selected database record. In some embodiments, selection of a particular database record may trigger the loading of a particular display layout configuration. Further, a particular application widget, which may present content, such as a video, may be tied to a particular record within the database. As such, selection of that database record by the user may trigger the particular display layout configuration to be presented and the associated content to be presented. For at least some of the other records within the database, selection does not trigger this particular display layout configuration and/or the content to be presented. For instance, a graph of payments received may only be available for certain customer records. As such, the graph may only be presented as a BI report in an application widget for the records which have sufficient information for the graph to be created and presented.

At step 980, a user may have the option to store the currently presented display layout configuration. Saving the display layout configuration may store an indication of: which application widgets and/or database interfaces are executed and presented in a frame within the composite application, which are executed application widgets and/or database interfaces but minimized within the composite application, and the layout and sizes of the display frames. The user may store the display layout configuration for his future use during another session with the composite application. The user may be permitted to make the display layout configuration public such that other users may use (but possibly not edit) the display layout configuration. The user may be permitted to name the display layout configuration. The user may be permitted to add a description for the display layout configuration.

At step 985, the user may select another record within a database interface of the composite application, which may cause the content of the first and/or second application widgets to be updated according to the now selected record. Step 985 may result in method 900 returning to step 960. At step 990, the user may select another display layout configuration, which may result in: some or all of the currently displayed application widgets and/or the database interface being rearranged and/or closed; and/or one or more additional application widgets and/or the database interfaces being executed and presented via frames in the composite application (or being executed, but displayed in a minimized/hidden format). Step 990 may result in method 900 returning to step 930.

A computer system as illustrated in FIG. 10 may be incorporated as part of the previously devices. For example, computer system 1000 can represent at least some of the components in a computerized system performing the functions described herein. FIG. 10 provides a schematic illustration of one embodiment of a computer system 1000 that can perform the methods provided by various other embodiments. It should be noted that FIG. 10 is meant only to provide a generalized illustration of various components, any or all of which may be utilized as appropriate. FIG. 10, therefore, broadly illustrates how individual system elements may be implemented in a relatively separated or relatively more integrated manner.

The computer system 1000 is shown comprising hardware elements that can be electrically coupled via a bus 1005 (or may otherwise be in communication, as appropriate). The hardware elements may include one or more processors 1010, including without limitation one or more general-purpose processors and/or one or more special-purpose processors (such as digital signal processing chips, graphics acceleration processors, and/or the like); one or more input devices 1015, which can include without limitation a mouse, a keyboard, and/or the like; and one or more output devices 1020, which can include without limitation a display device, a printer, and/or the like.

The computer system 1000 may further include (and/or be in communication with) one or more non-transitory storage devices 1025, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable and/or the like. Such storage devices may be configured to implement any appropriate data stores, including without limitation, various file systems, database structures, and/or the like.

The computer system 1000 might also include a communications subsystem 1030, which can include without limitation a modem, a network card (wireless or wired), an infrared communication device, a wireless communication device, and/or a chipset (such as a Bluetooth™ device, an 802.11 device, a WiFi device, a WiMax device, cellular communication facilities, etc.), and/or the like. The communications subsystem 1030 may permit data to be exchanged with a network (such as the network described below, to name one example), other computer systems, and/or any other devices described herein. In many embodiments, the computer system 1000 will further comprise a working memory 1035, which can include a RAM or ROM device, as described above.

The computer system 1000 also can comprise software elements, shown as being currently located within the working memory 1035, including an operating system 1040, device drivers, executable libraries, and/or other code, such as one or more application programs 1045, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a non-transitory computer-readable storage medium, such as the non-transitory storage device(s) 1025 described above. In some cases, the storage medium might be incorporated within a computer system, such as computer system 1000. In other embodiments, the storage medium might be separate from a computer system (e.g., a removable medium, such as a compact disc), and/or provided in an installation package, such that the storage medium can be used to program, configure, and/or adapt a general purpose computer with the instructions/code stored thereon. These instructions might take the form of executable code, which is executable by the computer system 1000 and/or might take the form of source and/or installable code, which, upon compilation and/or installation on the computer system 1000 (e.g., using any of a variety of generally available compilers, installation programs, compression/decompression utilities, etc.), then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 1000) to perform methods in accordance with various embodiments of the invention. According to a set of embodiments, some or all of the procedures of such methods are performed by the computer system 1000 in response to processor 1010 executing one or more sequences of one or more instructions (which might be incorporated into the operating system 1040 and/or other code, such as an application program 1045) contained in the working memory 1035. Such instructions may be read into the working memory 1035 from another computer-readable medium, such as one or more of the non-transitory storage device(s) 1025. Merely by way of example, execution of the sequences of instructions contained in the working memory 1035 might cause the processor(s) 1010 to perform one or more procedures of the methods described herein.

The terms “machine-readable medium” and “computer-readable medium,” as used herein, refer to any medium that participates in providing data that causes a machine to operate in a specific fashion. In an embodiment implemented using the computer system 1000, various computer-readable media might be involved in providing instructions/code to processor(s) 1010 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the non-transitory storage device(s) 1025. Volatile media include, without limitation, dynamic memory, such as the working memory 1035.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 1010 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 1000.

The communications subsystem 1030 (and/or components thereof) generally will receive signals, and the bus 1005 then might carry the signals (and/or the data, instructions, etc. carried by the signals) to the working memory 1035, from which the processor(s) 1010 retrieves and executes the instructions. The instructions received by the working memory 1035 may optionally be stored on a non-transitory storage device 1025 either before or after execution by the processor(s) 1010.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the invention. Also, a number of steps may be undertaken before, during, or after the above elements are considered. Accordingly, the above description does not bind the scope of the claims.

What is claimed is:

1. A method for managing a layout within a composite application, the method comprising:
receiving, by a computer system, selection of a first application widget, wherein
content of the first application widget is based at least in part on content of a selected record within a database interface presented as part of the composite application;
receiving, by the computer system, selection of a second application widget, wherein
content of the second application widget is based at least in part on content of the selected record within the database interface presented as part of the composite application;
receiving, by the computer system, a definition of a display layout configuration which defines display sizes and display positions of the first application widget, the second application widget, and the database interface for simultaneous presentation;
arranging, by the computer system, the first application widget, the second application widget, and the database interface in accordance with the display layout configuration; and
outputting, by the computer system, for presentation the composite application having the first application widget, the second application widget, and the database interface arranged according to the display layout configuration.

2. The method for managing the layout within the composite application of claim 1, the method further comprising:
receiving, by the computer system, selection of a record within the database interface of the composite application thereby making the record the selected record, wherein the record is selected from a plurality of records presented within the database interface of the composite application; and
in response to receiving selection of the record within the database interface of the composite application, modifying, by the computer system, content of the first application widget and content of the second application widget based on content of the record.

3. The method for managing the layout within the composite application of claim 2, wherein:
the first application widget presents content based on a generic universal resource indicator, the method further comprising:
creating, by the computer system, the generic universal resource indicator for the selected record by modifying a parameter of a universal resource indicator using data from the selected record; and
using, by the computer system, the created generic universal resource indicator to retrieve a resource for presentation within the first application widget.

4. The method for managing the layout within the composite application of claim 3, the method further comprising:
receiving, by the computer system, the universal resource indicator, wherein
the universal resource indicator comprises one or more parameters;
presenting, by the computer system, an interface that permits the one or more parameters to be selected and mapped to a variable;
receiving, by the computer system, a selection of the parameter to be mapped to the variable; and
receiving, by the computer system, an indication of the variable to map to the parameter of the selection, wherein the variable is a field present within the plurality of records.

5. The method for managing the layout within the composite application of claim 3, wherein:
the second application widget presents content based on a business intelligence definition, the method further comprising:
creating, by the computer system, a business intelligence report according to the business intelligence definition for the selected record.

6. The method for managing the layout within the composite application of claim 3, the method further comprising:
after presenting the composite application having the first application widget, the second application widget, and the database interface arranged according to the display layout configuration, receiving, by the computer system, a selection of a stored display layout configuration, wherein the stored display layout configuration defines display sizes and display positions for a third application widget and the database interface within the composite application; and
outputting, by the computer system, for presentation the composite application having the third application widget and the database interface arranged according to the stored display layout configuration.

7. The method for managing the layout within the composite application of claim 1, the method further comprising:
receiving selection of a second record within the database interface thereby making the second record the selected record, wherein the second record is linked to content and the content is only linked to the second record of a plurality of records; and
outputting, by the computer system, for presentation the composite application having a third application widget for presenting the content.

8. The method for managing the layout within the composite application of claim 1, wherein receiving the definition of the display layout configuration which defines display sizes and display positions of the first application widget, the second application widget, and the database interface comprises:
dragging and dropping to position and define display sizes of the first application widget, the second application widget, and the database interface within the composite application.

9. The method for managing the layout within the composite application of claim 1, further comprising:
storing, by the computer system, the definition of the display layout configuration.

10. A system for managing a layout within a composite application, the system comprising:
one or more processors; and
a memory communicatively coupled with and readable by the one or more processors and having stored therein processor-readable instructions which, when executed by the one or more processors, cause the one or more processors to:
receive selection of a first application widget, wherein
content of the first application widget is based at least in part on content of a selected record within a database interface presented as part of the composite application;
receive selection of a second application widget, wherein
content of the second application widget is based at least in part on content of the selected record within the database interface presented as part of the composite application;
receive a definition of a display layout configuration which defines display sizes and display positions of the first application widget, the second application widget, and the database interface for simultaneous presentation;
arrange the first application widget, the second application widget, and the database interface in accordance with the display layout configuration; and
cause presentation of the composite application having the first application widget, the second application widget, and the database interface arranged according to the display layout configuration.

11. The system for managing the layout within the composite application of claim 10, wherein the processor-readable instructions, when executed, further cause the one or more processors to:
receive selection of a record within the database interface of the composite application thereby making the record the selected record, wherein the record is selected from a plurality of records presented within the database interface of the composite application; and
in response to receiving selection of the record within the database interface of the composite application, modify content of the first application widget and content of the second application widget based on content of the record.

12. The system for managing the layout within the composite application of claim 11, wherein:
the first application widget presents content based on a generic universal resource indicator, and the processor-readable instructions, when executed, further cause the one or more processors to:
create the generic universal resource indicator for the selected record by modifying a parameter of a universal resource indicator using data from the selected record; and
use the created generic universal resource indicator to retrieve a resource for presentation within the first application widget.

13. The system for managing the layout within the composite application of claim 12, wherein the processor-readable instructions, when executed, further cause the one or more processors to:
receive the universal resource indicator, wherein
the universal resource indicator comprises one or more parameters;
cause presentation of an interface that permits the one or more parameters to be selected and mapped to a variable;
receive a selection of the parameter to be mapped to the variable; and
receive an indication of the variable to map to the parameter of the selection, wherein the variable is a field present within the plurality of records.

14. The system for managing the layout within the composite application of claim 12, wherein:
the second application widget presents content based on a business intelligence definition, and the processor-readable instructions, when executed, further cause the one or more processors to:
create a business intelligence report according to the business intelligence definition for the selected record.

15. The system for managing the layout within the composite application of claim 12, wherein the processor-readable instructions, when executed, further cause the one or more processors to:
after causing presentation of the composite application having the first application widget, the second application widget, and the database interface arranged according to the display layout configuration, receive a selection of a stored display layout configuration, wherein the stored display layout configuration defines display sizes and display positions for a third application widget and the database interface within the composite application; and
cause presentation of the composite application having the third application widget and the database interface arranged according to the stored display layout configuration.

16. The system for managing the layout within the composite application of claim 10, wherein the processor-readable instructions, when executed, further cause the one or more processors to:
receive selection of a second record within the database interface thereby making the second record the selected record, wherein the second record is linked to content and the content is only linked to the second record of a plurality of records; and
cause presentation of the composite application having a third application widget for presenting the content.

17. The system for managing the layout within the composite application of claim 10, wherein the processor-readable instructions that cause the one or more processors to receive the definition of the display layout configuration which defines display sizes and display positions of the first application widget, the second application widget, and the database interface further comprises processor-readable instructions that cause the one or more processors to:
receive user input to position and define display sizes of the first application widget, the second application widget, and the database interface within the composite application.

18. The system for managing the layout within the composite application of claim 10, wherein the processor-readable instructions, when executed, further cause the one or more processors to:
store the definition of the display layout configuration.

19. A non-transitory processor-readable medium for managing a layout within a composite application, comprising processor-readable instructions configured to cause one or more processors to:
receive selection of a first application widget, wherein
content of the first application widget is based at least in part on content of a selected record within a database interface presented as part of the composite application;
receive selection of a second application widget, wherein
content of the second application widget is based at least in part on content of the selected record within the database interface presented as part of the composite application;
receive a definition of a display layout configuration which defines display sizes and display positions of the first application widget, the second application widget, and the database interface for simultaneous presentation;
arrange the first application widget, the second application widget, and the database interface in accordance with the display layout configuration; and
cause presentation of the composite application having the first application widget, the second application widget, and the database interface arranged according to the display layout configuration.

20. The non-transitory processor-readable medium of claim 19, wherein the processor-readable instructions, when executed, further cause the one or more processors to:
receive selection of a record within the database interface of the composite application thereby making the record the selected record, wherein the record is selected from a plurality of records presented within the database interface of the composite application; and
in response to receiving selection of the record within the database interface of the composite application, modify content of the first application widget and content of the second application widget based on content of the record.
